(19) United States
(12) Patent Application Publication
(10) Pub. No.: US 2026/0281296 A1
(43) Pub. Date: Sep. 17, 2026

(54) SYSTEMS AND METHODS FOR VIDEO FRAME ALIGNMENT

(71) Applicant: Y.E. Hub Armenia LLC, Yerevan (AM)

(72) Inventors: Sergei ELISEEV, Moscow (RU); Leonid SHTANKO, Moscow (RU)

(21) Appl. No.: 19/459,405

(22) Filed: Jan. 26, 2026

(30) Foreign Application Priority Data
Mar. 11, 2025 (EA) 202590632

(51) Int. Cl. H04N 13/167; H04N 13/282

(52) U.S. Cl. CPC H04N 13/167; H04N 13/282

(57) ABSTRACT

Methods, systems and processors for video frame alignment are disclosed. The processor is configured to trigger playback of a reference audio signal, acquire lead camera data and aux camera data recorded during playback of the reference audio signal, synchronize, using a target lead audio frame and a target aux audio frame, the sequence of lead video frames and the sequence of aux video frames, and generate at least one artificial video frame for at least one of the sequence of lead video frames and the sequence of aux video frames. The processor is configured to generate aligned sequences of lead video frames and aux video frames. The processor is configured to perform 3D reconstruction using the aligned sequences of lead video frames and aux video frames.

### CROSS-REFERENCE

The present application claims priority to Eurasian Patent Application EA 202590632, entitled “Systems and Methods for Video Frame Alignment”, filed Mar. 11, 2025, the entirety of which is incorporated herein by reference.

### TECHNICAL FIELD

The present technology generally pertains to 3D scene reconstruction and, in particular, to systems and methods for video frame alignment.

### BACKGROUND

The present disclosure relates to systems of cameras, for example, to camera arrays or cameras clusters. Applications for the systems of cameras may include, but are not limited to, a camera system for a vehicle, a camera system for a robot, a stereoscopic filming tool, and other applications with virtual or augmented presence. A system of cameras may support a panoptic virtual presence application, designed to create a realistic sense of being in another place by providing an immersive 3D virtual reality (VR) viewing experience. Creating such an VR experience may involve generation of the three dimensional (3D) video for a scene. Yet another application for a system of cameras may be support of 3D rendering in video games.

In the realm of video production and surveillance, synchronizing video frames from multiple cameras has traditionally been a complex task. Previous approaches have often relied on timecode systems, where each camera is equipped with a high precision clock that stamps each frame with a time reference. However, the setup and maintenance of timecode systems may be cumbersome and costly, especially in the systems with numerous cameras. This method, may be also prone to drift over time as the high precision clocks are not perfectly synchronized.

U.S. Pat. No. 10,694,167 discloses a camera array, and a switch configured to instruct each of the camera modules to initiate a start operation to start recording video data to initiate a stop operation to stop recording.

In network-based synchronization methods, all the cameras may be connected to a central server that coordinates the timing of frame capture. These systems may utilize protocols such as the Precision Time Protocol (PTP) to achieve synchronization. However, the network-based synchronization methods are costly. They dependent on the reliability and latency of the network infrastructure. In environments with unstable network conditions, synchronization accuracy may degrade, leading to misalignment of video frames.

### SUMMARY

Developers of the present technology have developed methods and systems for reconstructing 3D sceneries using multiple camera devices. To reconstruct a 3D scene, camera devices can capture video frames in parallel. In accordance with the non-limiting embodiments of the present technology, the reconstruction of the 3D scene can be performed after the video frames are captured by the multiple camera devices, i.e. be implemented as a post-processing method. To that end, the video frames from multiple camera devices undergo a video frame alignment process.

Developers of the present technology have developed methods and systems for aligning video frames of multiple media recordings using a reference audio signal. Broadly, video frame alignment refers to the process of synchronizing and matching (and/or adjusting) video frames captured from multiple cameras to ensure proper temporal and spatial correspondence. This process is executed for combining footage from different camera devices for applications such as 3D scene reconstruction, for example.

In the context of the present technology, an “audio template” refers to an audio recording that can be used to generate a reference audio signal. The reference audio signal may be played back during recording of video frames by the plurality of camera devices. For example, the audio template may have a sampling rate of 48 kHz, may be 10 seconds long, and representing a siren sound that starts at 50 Hz, gradually increases to 400 Hz by the midpoint, and then decreases back to 50 Hz. It is contemplated that an audio template profile may have a start frequency that matches its end frequency, ensuring a smooth transition without abrupt jumps. Such an audio template may be well-suited for transmission over wires and resistant to distortion by audio codecs. Other audio template profiles are contemplated. It should be expressly understood that any type up of a reference signal can be used for the audio template implementations.

In the context of the present technology, an “reference audio signal” or sometimes referred to as an audio track may be a continuously looped sequence of the audio template, played back during recording of the video frames by the camera devices. For example, the reference audio signal may have a total duration of 3 hours. In some embodiments, the reference audio signal may be provided to one or more camera devices using a wired connection. In other embodiments, the reference audio signal may be playedback by a given audio player for one or more camera devices simultaneously.

In the context of the present technology, an “audio player” refers to a device that is configured to playback the reference audio signal.

In the context of the present technology, an “audio frame” refers to an audio data unit captured by a camera device within a sequence of audio frames. For example, the audio frame may be a 16-bit data unit, with 48,000 frames recorded per second by the camera device.

In the context of the present technology, a “camera audio signal” refers to a recorded audio signal by a given camera device captured at a specific sampling rate and linked to the corresponding video signal. For example, the camera audio signal may be a recording of the reference audio signal performed by a corresponding camera device.

In the context of the present technology, a “camera rig” may refer to a group of camera devices that are configured to record both video and audio streams. One or more camera devices may have an internal oscillator that provides timing signals for the audio and video buffers during recording. It is contemplated that audio and video streams within a single camera device are synchronized, meaning they share the same oscillator, and their frequencies remain consistent in oscillator “tick” terms. For example, if a camera records audio at 48,000 Hz and video at 100 Hz, there will be one video frame for every 480 audio samples.

In the context of the present technology, a “lead camera device” refers to a given camera device from the camera rig, the data of which is used as primary data for data processing during video frame alignment process.

In the context of the present technology, a “video frame” refers to an image captured by a camera device at a given moment in time. For example, the video frame may be a 2D image, with 100 frames recorded per second by the camera device.

In the context of the present technology, a “sequence of video frames” refers to a video signal captured by a camera device and comprises a plurality of video frames recorded at respective moments in time.

In the context of the present technology, a “interpolator” refers to a Neural Network (NN) configured to interpolate between two or more consecutive video frames to generate an artificial frame for a given timestamp between the two or more consecutive video frames.

Developers have realized that by determining the specific timestamp of each video frame, frame sequences from different camera devices can be synchronized. Also, a first sequence of frames from a first camera can be used to generate artificial frames to be added to the first sequence of frames for matching frames of a synchronized sequence of frames from a second camera.

In some embodiments of the present technology, there is provided a multi-camera system configured to capture camera data from multiple cameras. An audio player can be connected to all cameras in parallel. All cameras may be configured to record at a same video and audio sampling rates. Recording may start simultaneously (or substantially simultaneously) on all cameras. The audio player may begin playing the audio track for all cameras. The recording may stop on all cameras. Camera data may comprise a set of video and audio files for each camera.

In some embodiments of the present technology, there is provided a multi-camera system configured to process camera data from multiple cameras. For each camera in the rig, a processor may extract the recorded audio signal. The processor may select an interval of 3 template lengths from the audio signal. The processor may use a correlation operation to locate the start of the template in the audio signal. The processor may identify the template's start position (e.g., corresponding to an audio frame index i). The processor may store a variable “TemplateCount=1”, indicating the template has been detected once. The processor may shift a window forward by a specific interval (e.g., ⅔ of a template length) in the audio signal. The processor may identify an overlapping segment such as half of a template length backward and three template lengths forward, for example. The processor may use an other correlation operation to locate the next template start. The processor may increase “TemplateCount” variable by 1 and repeat the process. As a result, certain audio frames will have a corresponding “TemplateCount” value. The processor may assign timestamps to respective audio frames based on template duration. The processor may assign timestamps to all audio frames using frequency and/or audio signal structure and/or other audio features. The processor may transfer the timestamps from audio frames to video frames using correlation between audio frames and video frames. As a result, each video frame of each camera device may now have a specific timestamp. The processor may calculate a necessary shift for each frame in aux camera i to align it with the corresponding frame of the lead camera. The processor may then perform at least a portion of an alignment procedure using the interpolator to generate artificial frames.

It is contemplated that a lead camera device may have a first video frame rate and an aux camera device may have a second video frame rate. In some embodiments, the first video frame rate may be the different from the second video frame rate. In other embodiments, the first video frame may be the same as the second video frame rate. In further embodiments, it should be noted that the oscillator of the lead camera and the oscillator of the aux camera may not be synchronized amongst each other—e.g., the “tics” of the oscillators may (or may not) be performed at a same frequency and may start at different moments in time (out of phase) before synchronization by the computer system.

In a first broad aspect of the present technology, there is provided a method for video frame alignment, the method executable by a processor, the method comprising: triggering playback of a reference audio signal; acquiring lead camera data from a lead camera device, the lead camera data being indicative of a sequence of lead video frames and a corresponding sequence of lead audio frames, the sequence of lead video frames and the corresponding sequence of lead audio frames have been recorded during playback of the reference audio signal; acquiring aux camera data from at least one aux camera device, the aux camera data including a sequence of aux video frames and a corresponding sequence of aux audio frames, the sequence of aux video frames and the corresponding sequence of aux audio frames have been recorded during playback of the reference audio signal; synchronizing, using a target lead audio frame and a target aux audio frame, the sequence of lead video frames and the sequence of aux video frames, the target aux audio frame matching the target lead audio frame; and generating at least one artificial video frame for at least one of the sequence of lead video frames and the sequence of aux video frames, thereby generating aligned sequences of lead video frames and aux video frames.

In some aspects, the techniques described herein relate to a method, wherein the lead camera device has a first frame rate, and the at least one aux camera device has a second frame rate, the first frame rate being different from the second frame rate.

In some aspects, the techniques described herein relate to a method, wherein the method further includes identifying the target lead audio frame and the target aux audio frame using audio features of reference audio signal.

In some aspects, the techniques described herein relate to a method, wherein the lead camera device is a standalone camera device.

In some aspects, the techniques described herein relate to a method, wherein the at least one aux camera device is a standalone camera device.

In some aspects, the techniques described herein relate to a method, wherein at least one of the sequence of lead audio frames and the sequence of aux audio frames has been recorded at a sampling rate of 48000 Hz.

In some aspects, the techniques described herein relate to a method, wherein at least one of the sequence of lead video frames and the sequence of aux video frames has been recorded at a sampling rate of 100 Hz.

In some aspects, the techniques described herein relate to a method, wherein the generating the at least one artificial video frame includes generating, using a Neural Network, an artificial lead video frame by interpolating at least two temporally adjacent lead video frames.

In some aspects, the techniques described herein relate to a method, wherein the generating at least one artificial video frame includes generating, using a Neural Network, an artificial aux video frame by interpolating at least two temporally adjacent aux video frames.

In some aspects, the techniques described herein relate to a method, wherein the method further includes executing 3D scene reconstruction using the aligned sequences of lead video frames and aux video frames.

In a second broad aspect of the present technology, there is provided a system comprising: a lead camera device; at least one aux camera device; and a processor configured to: trigger playback of a reference audio signal; acquire lead camera data from the lead camera device, the lead camera data being indicative of a sequence of lead video frames and a corresponding sequence of lead audio frames, the sequence of lead video frames and the corresponding sequence of lead audio frames have been recorded during playback of the reference audio signal; acquire aux camera data from at least one aux camera device, the aux camera data including a sequence of aux video frames and a corresponding sequence of aux audio frames, the sequence of aux video frames and the corresponding sequence of aux audio frames have been recorded during playback of the reference audio signal; synchronize, using a target lead audio frame and a target aux audio frame, the sequence of lead video frames and the sequence of aux video frames, the target aux audio frame matching the target lead audio frame; and generate at least one artificial video frame for at least one of the sequence of lead video frames and the sequence of aux video frames, thereby generating aligned sequences of lead video frames and aux video frames.

In some aspects, the techniques described herein relate to a system, wherein the lead camera device has a first frame rate, and the at least one aux camera device has a second frame rate, the first frame rate being different from the second frame rate.

In some aspects, the techniques described herein relate to a system, wherein the processor is further configured to identify the target lead audio frame and the target aux audio frame using audio features of reference audio signal.

In some aspects, the techniques described herein relate to a system, wherein the lead camera device is a standalone camera device.

In some aspects, the techniques described herein relate to a system, wherein the at least one aux camera device is a standalone camera device.

In some aspects, the techniques described herein relate to a system, wherein at least one of the sequence of lead audio frames and the sequence of aux audio frames has been recorded at a sampling rate of 48000 Hz.

In some aspects, the techniques described herein relate to a system, wherein at least one of the sequence of lead video frames and the sequence of aux video frames has been recorded at a sampling rate of 100 Hz.

In some aspects, the techniques described herein relate to a system, wherein the generating the at least one artificial video frame includes generating, using a Neural Network, an artificial lead video frame by interpolating at least two temporally adjacent lead video frames.

In some aspects, the techniques described herein relate to a system, wherein the generating at least one artificial video frame includes generating, using a Neural Network, an artificial aux video frame by interpolating at least two temporally adjacent aux video frames.

In some aspects, the techniques described herein relate to a system, wherein the method further includes executing 3D scene reconstruction using the aligned sequences of lead video frames and aux video frames.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

Further features and advantages of the present invention will become apparent from the following detailed description, taken in combination with the appended drawings, in which:

FIG. 1 is a schematic diagram of a computer system in accordance with at least some embodiments of the present technology.

FIG. 2 illustrates an example of a multi-camera system according to some non-limiting embodiments.

FIG. 3 illustrates the sequence of lead video frames and the sequence of aux video frames recorded by the lead camera and a first aux camera, respectively.

FIG. 4 illustrates an example of artificial frames being generated based on neighboring video frames.

FIG. 5 illustrates aligned sequences of lead video frames and first aux video frames following an alignment process performed by the computer system of FIG. 1 on the sequence of lead video frames and the sequence of aux video frames of FIG. 3.

FIG. 6 illustrates a flowchart of the method for video frame sequence synchronization in accordance with some non-limiting embodiments.

It will be noted that throughout the appended drawings, like features are identified by like reference numerals.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

The functions of the various elements shown in the figures, including any functional block labelled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

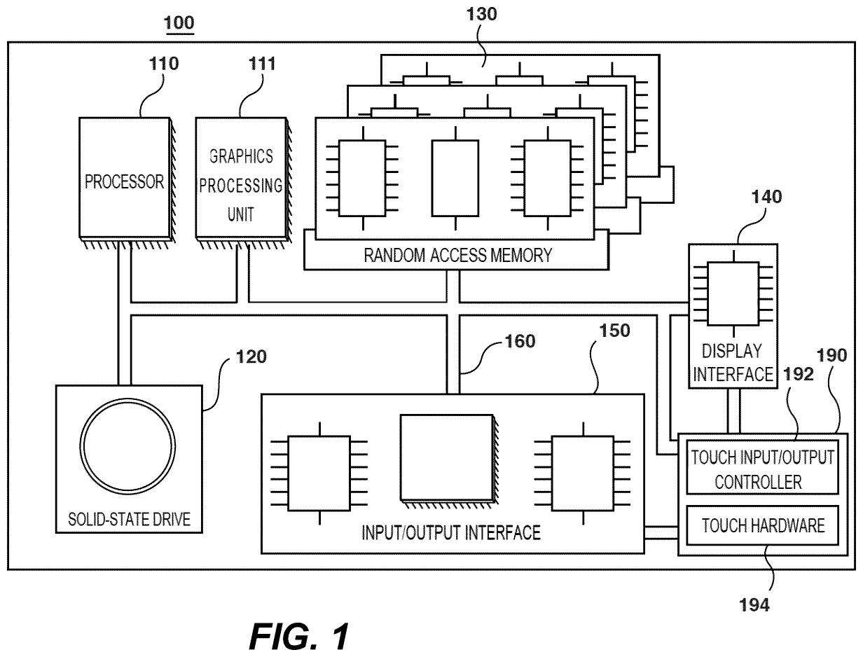

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

According to implementations of the present technology, the solid-state drive 120 stores program instructions suitable for being loaded into the random-access memory 130 and executed by the processor 110 and/or the GPU 111. For example, the program instructions may be part of a library and/or an application.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. It is noted that some components of the computer system 100 can be omitted in some non-limiting embodiments of the present technology. For example, the keyboard and the mouse (both not separately depicted) can be omitted, especially (but not limited to) where the computer system 100 is implemented as a compact electronic device.

Broadly speaking, the touchscreen 190 may comprise touch hardware 194 and a touch input/output controller 192 allowing communication with the display interface 140 and/or the one or more internal and/or external buses 160. In some embodiments, the touch hardware 194 may comprise pressure-sensitive cells embedded in a layer of a display allowing detection of a physical interaction between a user and the display.

It is contemplated that the computer system 100 may comprise an audio playing device configured to decode, process, and output audio signals for playback. It typically comprises hardware and software components that convert digital or analog audio data into sound waves, as is known in the art, and which can be transmitted through built-in or external speakers, headphones, or other audio output systems.

It should be noted that various implementations of the computer system 100 are contemplated. As it will become apparent from the description herein further below, one or more computer system connected over communication network may be implemented similarly to the computer system 100, without departing from the scope of the present technology.

### Multi-Camera System

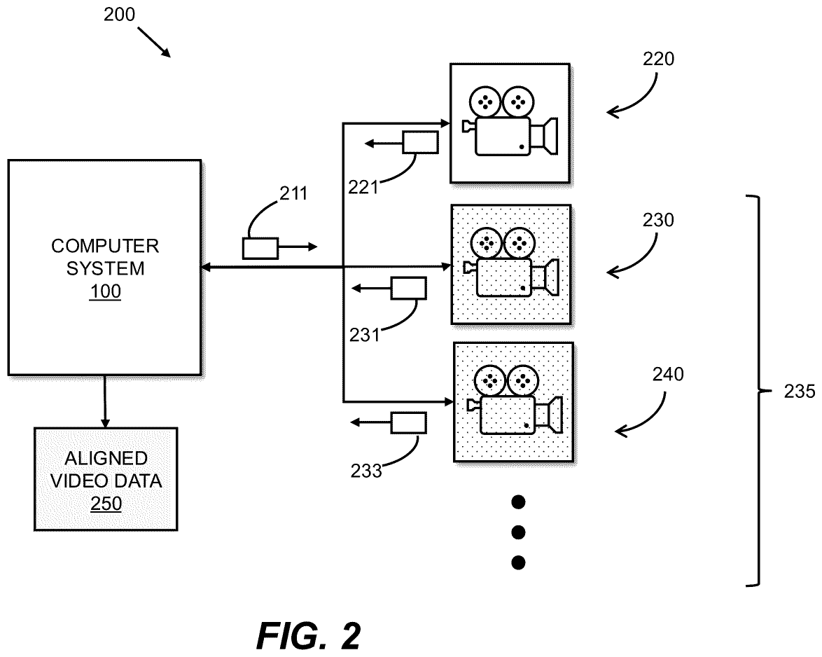

With reference to FIG. 2, there is depicted a multi-camera system 200 as envisioned in at least some non-limiting embodiments of the present technology. The multi-camera system 200 comprises the computer system 100, a lead camera device 220, and a plurality of aux camera devices 235. For example, the plurality of aux camera devices 235 comprises a first aux camera device 230 and a second aux camera device 240. However, in other embodiments, the multi-camera system 200 may comprise more than two, or a single aux camera device, without departing from the scope of the present technology.

Each one of the lead camera device 220 and the plurality of aux camera devices 235 may be implemented as an “off-the-shelf” camera device, without departing from the scope of the present technology.

Broadly speaking, a given camera device (such as the lead camera device 220, the first aux camera device 230, and the second aux camera device 240, for example) comprises an image sensor configured to capture a sequence of video frames and an audio sensor configured to capture corresponding audio frames. The camera device may further comprise a processing unit operatively coupled to the image sensor and the audio sensor, wherein the processing unit is configured to process and store the captured video frames and audio frames as camera data. The camera device may also comprise a memory for storing the camera data and a communication interface for transmitting the camera data to an external device, such as the computer system 100, for example. The frame rate of the camera device may be adjustable and/or may depend on inter alia various implementations of the present technology.

It is contemplated that the camera device may be implemented as a “standalone” camera device designed for capturing high-quality images and/or videos in various environments. In one implementation, a given standalone camera device may be a GoPro™ camera device. For example, the standalone camera device may be a compact and portable device with (or without) a durable housing that is resistant to water, dust, and/or impact, making it suitable for outdoor and action-oriented applications. It is contemplated that the standalone camera device may be equipped with a built-in processor for real-time image processing, video stabilization, and various recording modes, including time-lapse, slow-motion and/or high-frame-rate video capture, for example. The standalone camera device may comprise an onboard storage and/or may support external storage of recorded content. The standalone camera device may comprise a rechargeable battery to power one or more functionalities of the standalone camera device. The standalone camera device may comprise a user interface including physical buttons, a touchscreen display, and/or voice control functionality for adjusting settings and/or controlling recording functions. The standalone camera device may support wireless connectivity options such as Wi-Fi™ and/or Bluetooth™ for transferring media files, remote control operation via a mobile application, and/or live streaming. The standalone camera device may be designed for versatile mounting options, comprising attachment to helmets, vehicles, tripods, and/or handheld stabilizers, making it suitable for sports, travel, vlogging and/or other dynamic recording applications.

It should be noted that standalone camera devices are inexpensive but are designed for standalone operation—i.e., these inexpensive camera devices do not include automatic video feed alignment functions for aligning video frames with frames from other camera devices. Developers of the present technology have devised methods and systems for employing such inexpressive standalone camera devices in multi-camera setups (e.g., camera rigs) where alignment of video feeds is managed through external software and/or hardware. As it will become apparent from the description herein further below, the computer system 100 may be configured to perform data processing for aligning video frames captured by a plurality of standalone camera devices.

The computer system 100 is configured to trigger transmission of a reference audio signal 211 and/or trigger playback of the reference audio signal 211 via a given audio player. It should be noted that the reference audio signal is wiredely transmitted to respective camera devices and/or played by a single player for all camera devices simultaneously. The lead camera device 220 and the plurality of aux camera devices 235 may be configured to record camera data while the reference audio track is being played. The computer system 100 is configured to acquire lead camera data 221 from the lead camera device 220, first aux camera data 231 from the first aux camera device 230, and second aux camera data 233 from the second aux camera device 240, and so forth. It is contemplated that the lead camera data 221 is indicative of a sequence of lead video frames recorded by the lead camera device 220 with a respective camera audio signal (recorded version of the reference audio signal 211 by the lead camera device 220), and the first aux camera data 231 is indicative of a sequence of first aux video frames recorded by the first aux camera device 230 with a respective camera audio signal (recorded version of the reference audio signal 211 by the first aux camera device 230).

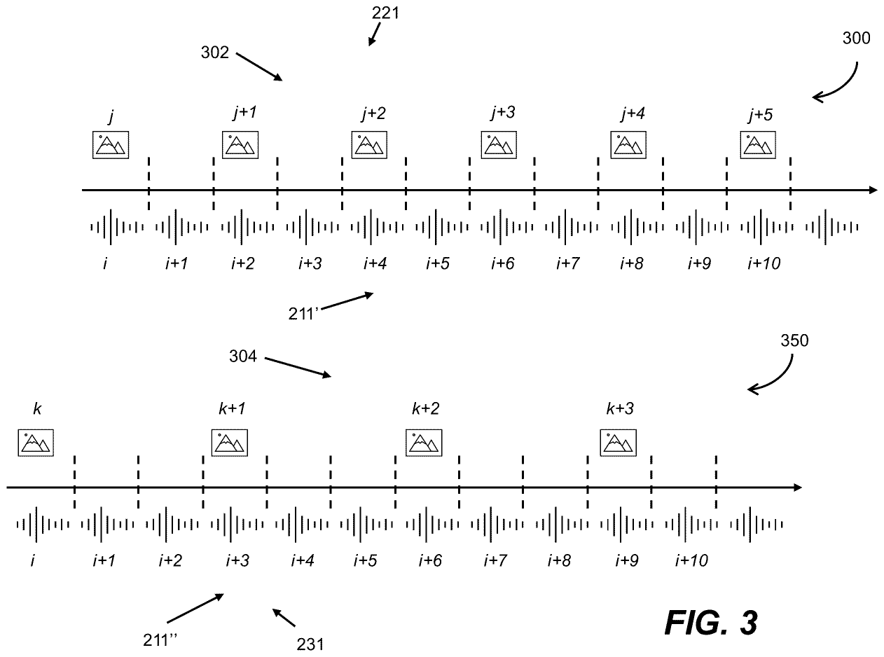

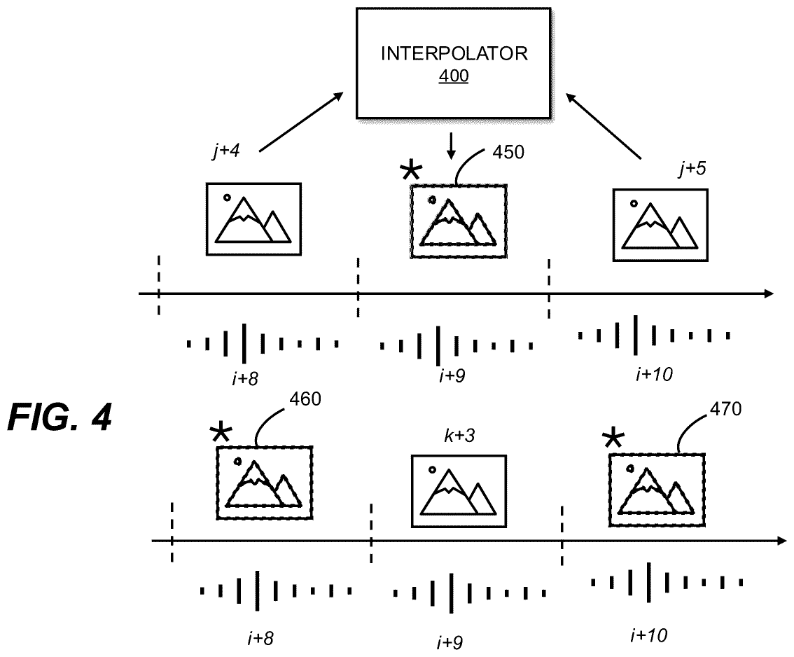

The computer system 100 may then be configured to generate aligned video data 250 by processing camera data acquired from the lead camera device 220 and the plurality of aux camera devices 235. How the camera data is processed by the computer system 100 will now be described with reference to FIGS. 3 and 4.

### Camera Data Processing

With reference to FIG. 3, there is depicted a schematic representation 300 of the lead camera data 221 acquired by the computer system 100 from the lead camera device 220, and a schematic representation 350 of the first aux camera data 231 acquired by the computer system 100 from the first aux camera device 230. Although the following description will make reference to processing of the first aux camera data 231 with the lead camera data 221, the computer system 100 may be configured to process one or more aux camera data streams from the plurality of aux camera devices 235 with the lead camera data 221, without departing from the scope of the present technology.

In this embodiment, the lead camera data 221 comprises a sequence of lead video frames 302 and a lead camera audio signal 211′. The lead camera audio signal 211′ represents at least in part the audio track (the reference audio signal 211) played by the computer system 100 and which has been recorded by the lead camera device 220 while recording the sequence of lead video frames 302. For example, the sequence of lead video frames 302 comprises lead video frames j, j+1, j+2, j+3, j+4, j+5, and so forth. The lead camera audio signal 211′ comprises lead audio frames i, i+1, i+2, i+3, i+4, i+5, i+6, i+7, i+8, i+9, i+10, and so forth. As seen, the lead video frame j has been recoded with the audio frame i, the lead video frame j+1 has been recoded with the audio frame i+2, the lead video frame j+2 has been recoded with the audio frame i+4, the lead video frame j+3 has been recoded with the audio frame i+6, the lead video frame j+4 has been recoded with the audio frame i+8, the lead video frame j+5 has been recoded with the audio frame i+10, and so forth. The computer system 100 may be configured to determine this correspondence between the lead video frames and the lead audio frames from the lead camera data 221.

In this embodiment, the first aux camera data 231 comprises a sequence of first aux video frames 304 and a first aux camera audio signal 211″. The first aux camera audio signal 211″ represents at least in part the audio track (the reference audio signal 211) played by the computer system 100 and which has been recorded by the first aux camera device 230 while recording the sequence of first aux video frames 304. For example, the sequence of first aux video frames 304 comprises first aux video frames k, k+1, k+2, k+3, and so forth. The first aux camera audio signal 211″ comprises first aux audio frames i, i+1, i+2, i+3, i+4, i+5, i+6, i+7, i+8, i+9, i+10, and so forth. As seen, the first aux video frame k has been recoded with the audio frame i, the first aux video frame k+1 has been recoded with the audio frame i+3, the first aux video frame k+2 has been recoded with the audio frame i+6, the lead video frame k+3 has been recoded with the audio frame i+9, and so forth. The computer system 100 may be configured to determine this correspondence between the first aux video frames and the first aux audio frames from the first aux camera data 221.

In accordance with the non-limiting embodiments of the present technology, the computer system 100 may be configured to determine which of the lead audio frames correspond to which first aux audio frames. For example, the computer system 100 may be configured to determine that the lead audio frame i matches the first aux audio frame i. In other words, the computer system 100 may be configured to perform an indexation procedure on the lead audio frames and on the first aux audio frames (and/or on other aux audio frames from other aux camera devices).

In one embodiment, the computer system 100 may extract the lead audio signal 211′ and the first aux audio signal 211″ from the lead camera data 221 and the first aux camera data 231, respectively. The computer system 100 may select an interval or “window” to analyse the audio signals. The computer system 100 may use features of the audios frames for indexation of audio frames in each audio signal. As a result, audio frames may be assigned with corresponding counters, such as i, i+1, i+2, and so forth, and which represent the timestamps for the audio frames.

In at least one non-limiting embodiment of the present technology, the computer system 100 may be configured to perform an indexing process according to the following logic. In this embodiment, the indexing process involves the use of a predefined audio template, which is a recorded sound pattern that plays in a looped configuration. This template has a duration of 10 seconds and is indicative of a siren signal encoded to sweep from 50 Hz to 100 Hz and back. In this embodiment, the encoding is performed at a sampling rate of 48,000 samples per second, where each sample represents the amplitude of the sound wave and is stored as a 2-byte value. The template is continuously looped and transmitted as an input audio signal to multiple cameras via wired connections, for example. Each camera records both video and audio, capturing the transmitted sound along with visual data. The recorded audio track from each camera retains the original structure of 48,000 frames per second, with each sample stored as a 2-byte value. It is contemplated that due to signal transmission and encoding processes, minor distortions may occur. In this embodiment, the camera devices also capture video at a frame rate of 100 frames per second and maintain synchronization between video frames and the recorded audio within a given camera device. Once the audio data is recorded, a correlation-based method may be used to detect the starting position of a repeating template within a recorded sequence. The recorded audio can be converted into numerical arrays for processing. In this embodiment, a search interval can be defined as the range according to a following equation (1):

$$range = [ start - \frac{1}{5} \times template length , start + 3 \times template length ] \qquad ( 1 )$$

It is contemplated that correlation values can be computed for different positions between a recorded signal and an original template. The position with the highest correlation value is identified as the starting point of the template in the recorded sequence. Once the starting position is determined, the known (e.g., target) audio frame rate is used to assign sequential indices to each recorded audio sample. The indexing window can move along the recorded audio track by a step size of ⅔ of the template length and repeats the correlation process to locate the next occurrence of the template. As a result, each audio sample can be assigned two with two numerical values: (i) a sequential template index indicating which iteration of the repeating template it belongs to, and (ii) a frame index specifying its position within that template iteration. Using these numerical values and the pre-determined duration of the template, timestamp labels can be generated and assigned to each audio frame in a sequence. Since the audio is synchronized with the video, the same timestamps can be applied to the corresponding video frames.

In this embodiment, the computer system 100 may be configured to identify a target lead audio frame i in the lead camera audio signal 211′, and a target first aux audio frame i in the first aux audio signal 211″. It should be noted that the target lead audio frame i in the lead camera audio signal 211′ matches the target first aux audio frame i in the first aux audio signal 211″. It is contemplated that the target lead audio frame i in the lead camera audio signal 211′ and the target first aux audio frame i in the first aux audio signal 211″ may have the same timestamp (i.e., index value) i in both the lead camera audio signal 211′ and the first aux audio signal 211″.

The computer system 100 is configured to synchronize the sequence of lead video frames 302 and the sequence of first aux video frames 304 using the target lead audio frame i the lead camera audio signal 211′ and the target first aux audio frame i in the first aux audio signal 211″ such that the lead video frame j is associated with a synched aux video frame k. In this example, in response to synchronization, the lead video frame j+3 is associated with a synched aux video frame k+2.

It should be noted however, that following the synchronization, some lead video frames may not have corresponding synced aux video frames and/or vice vera. For example, the lead video frame j+1 may not have a synced first aux video frame. This may occur, for example, in scenarios where the video frame rate of the lead camera device 220 does not match the video frame rate of the first aux camera device 230.

It is contemplated that the computer system 100 may be configured to generate one or more artificial video frames for the sequence of lead video frames 302 and/or for the sequence of first aux video frames 304. How the computer system 100 is configured to generate artificial video frames will be described with reference to FIG. 4.

### Artificial Frame Generation

With reference to FIG. 4, there is depicted a schematic illustration of an interpolator 400 used to generate an artificial lead video frame 450 and/or artificial aux video frames 460 and 470. It is contemplated that in at least some embodiments, the interpolator 400 may be employed to generate solely artificial aux frames for one or more synchronized sequences of aux video frames, without generating any artificial frames for the sequence of lead video frames, without departing from the scope of the present technology.

In some embodiments, the sequence of lead video frames 302 may not have a lead frame associated with a lead audio frame i+9, the computer system 100 may be configured to use at least two neighbouring lead video frames for generating the artificial video frame 450 corresponding to the lead audio frame i+9.

As a result, the computer system 100 may be configured to feed the interpolator 400 with the lead video frame j+4 and with the lead video frame j+5 to perform an interpolation operation resulting in the artificial video frame 450.

Broadly speaking, the interpolator 400 may be embodied as a Neural Network (NN) configured to generate artificial video frames by analysing two, or more, of neighbouring frames. The interpolator 400 may be used to enhance video fluidity by estimating and synthesizing intermediate frames between existing frames, thereby increasing frame rate and/or improving motion continuity. The NN may be trained to receive at least two temporally adjacent video frames as input. The NN can analyse motion patterns, pixel trajectories and/or scene dynamics between the input frames to predict and generate an interpolated frame representing an estimated intermediate moment in time. The NN may leverage techniques such as optical flow estimation, deep learning-based motion compensation, and/or Generative Adversarial Networks (GANs) to improve the accuracy and realism of the artificial frames. The NN may process multiple consecutive frames, adapt to different frame rates, and/or apply post-processing enhancements such as artifact reduction, temporal consistency correction and/or adaptive frame blending. As such, the interpolator 400 can be used in various applications, comprising video upscaling, slow-motion video generation, and/or frame rate conversion. The interpolator 400 may operate as a standalone software module during video feed processing pipeline for generating one or more artificial video frames.

Once the artificial lead video frame 450 is generated, the computer system 100 may associate with artificial video frame 450 with the synced first aux video frame k+3 since it shares the corresponding first aux audio frame i+9.

In additional embodiments, the computer system 100 may be configured to generate artificial first aux video frames 460 and 470 based on neighbouring first aux video frames in a similar manner to how the artificial lead video frame 450 is generated. Once the artificial first aux video frame 460 is generated, the computer system 100 may associate the artificial first aux video frame 460 with the synced lead video frame j+4 since it shares the corresponding lead audio frame i+8. Once the artificial first aux video frame 470 is generated, the computer system 100 may associate the artificial first aux video frame 470 with the synced lead video frame j+5 since it shares the corresponding lead audio frame i+10.

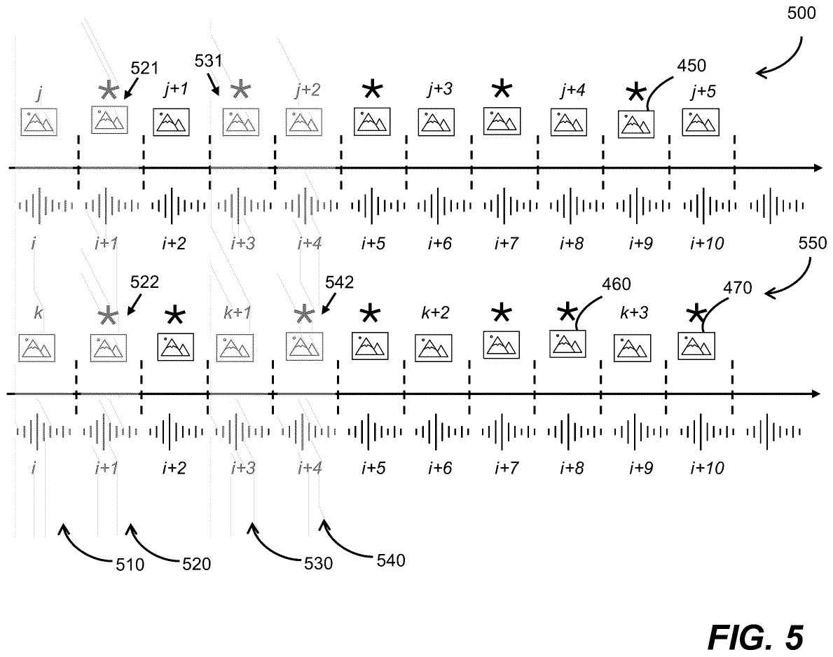

With reference to FIG. 5, there is depicted aligned sequences of lead video frames 500 and first aux lead video frames 550. The aligned sequence of lead video frames 500 also comprises timestamps (index values) for respective video frames from the aligned sequence of lead video frames 500. The aligned sequence of first aux video frames 550 also comprises timestamps (index values) for respective frames from the aligned sequence of lead video frames 500. The timestamps (index values) for the aligned sequences of lead video frames 500 and first aux lead video frames 550 have been generated during a synchronization procedure based on audio features.

The aligned sequence of lead video frames 500 comprises the sequence of lead video frames 302 and a plurality of artificial lead video frames (comprising the artificial lead video frame 450). The aligned sequence of first aux video frames 550 comprises the sequence of first aux video frames 304 and a plurality of artificial first aux video frames (comprising the artificial first aux video frames 460 and 470).

In a first example, a first aligned set of frames 510 comprises the lead video frame j and the first aux video frame k. In a second example, a second aligned set of frames 520 comprises an artificial lead video frame 521 and an artificial first aux video frame 522. In a third example, a third aligned set of frames 530 comprises an artificial lead video frame 531 and the first aux video frame k+1. In a fourth example, a fourth aligned set of frames 540 comprises the lead video frame j+2 and an artificial first aux video frame 542.

It should be noted that sets of aligned video frames from multiple camera devices may serve as a dataset for 3D scene reconstruction. The processing pipeline for 3D scene reconstruction may comprise feature extraction, depth estimation, and model generation, to transform 2D video frames into a coherent 3D representation.

In some embodiments, the computer system 100 may be configured to perform a 3D reconstruction process for reconstructing a 3D representation of a scene using video frames (images) captured by multiple camera devices. The 3D reconstruction is performed by processing frames from a lead camera and interpolating corresponding frames from one or more aux cameras to obtain a synchronized set of images for each frame of the lead camera. For each synchronized frame, the computer system 100 may be configured to perform a following sequence of steps: normalization estimation, segmentation, geometry reconstruction and text mesh generation. During, normal estimation, surface normals are estimated for each image in the synchronized set of frame images. The surface normals provide information about the orientation of surfaces in the scene. During segmentation, images are segmented to separate the object of interest from the background. Segmentation ensures that only relevant portions of the scene are considered in further processing. During geometry reconstruction, using the estimated surface normals and segmented object regions, an initial approximation of the scene's geometry is reconstructed. This results in a a rough 3D structure of the captured object. During textured mesh generation, approximate geometry is converted into a textured 3D mesh, where the surface is represented by a network of vertices and edges, and a texture is applied to enhance realism. During mesh optimization, the generated mesh is further refined using an optimization process. The positions of the mesh vertices and the texture colors are adjusted so that the rendered appearance of the mesh closely matches the original captured images. Additionally, the surface normals of the mesh faces can be optimized to align with the previously estimated surface normals.

### Method

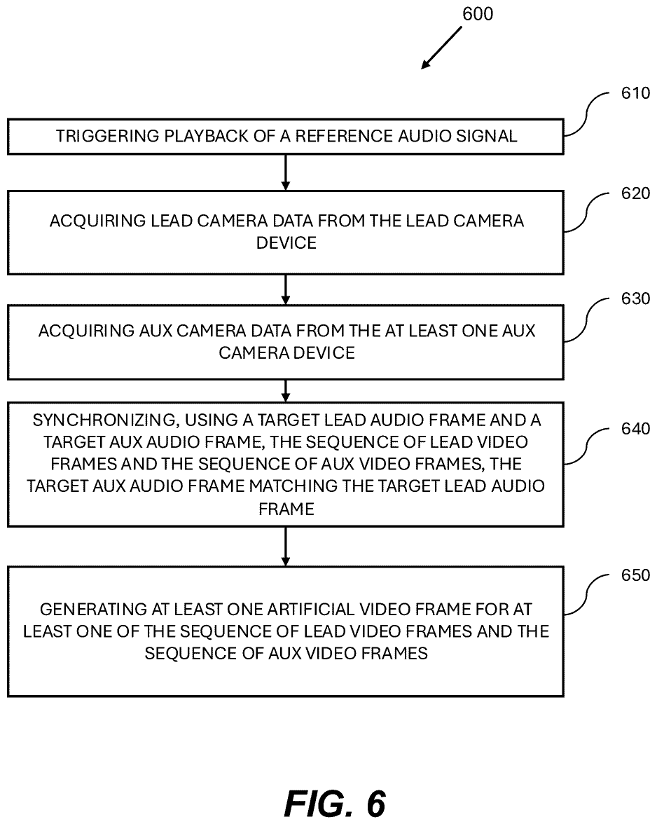

With reference to FIG. 6, there is depicted a scheme-block representation of a method 600 executable by a processor of the computer system 100. Various steps of the method 600 will now be described in greater details herein further below.

### Step 610: Triggering Playback of a Reference Audio Signal

At step 610, the processor 110 is configured to trigger playback of a reference audio signal. The reference audio signal may be a sequence of template audio signals. The processor 110 may be configured to trigger one or more audio players to generate audio waves representative of the reference audio signal.

In at least some embodiments of the present technology, the computer system 100 may be configured to transmit the reference audio signal to a plurality of camera devices via wired connections. In some embodiments, the processor 110 may trigger playback of the reference signal by the one or more camera devices.

In other embodiments of the present technology, the computer system 100 may be configured to transmit the reference audio signal to an audio player configured to playback the reference audio signal to the plurality of camera devices simultaneously. In some embodiments, the processor 110 may trigger playback of the reference signal by the audio player.

Step 620: Acquiring Lead Camera Data from a Lead Camera Device

At step 620, the processor 110 is configured to acquire from the lead camera device 220 the lead camera data 221. For example, lead camera device 220 data may comprise a sequence of lead video frames and a sequence of lead audio frames. The sequences of lead video and audio frames have been recorded during playback of the reference audio signal. The sequence of lead video and audio frames may have different sampling rates, without departing from the scope of the present technology.

Step 630: Acquiring Aux Camera Data from at Least One Aux Camera Device

At step 630, the processor 110 is configured to acquire from the first aux camera device 230 the first aux camera data 231. For example, the first aux camera device 230 data may comprise a sequence of aux video frames and a sequence of aux audio frames. The sequences of aux video and audio frames have been recorded during playback of the reference audio signal. The sequence of aux video and audio frames may have different sampling rates, without departing from the scope of the present technology.

### Step 640: Synchronizing, Using the Target Lead Audio Frame and the Target Aux Audio Frame, the Sequence of Lead Video Frames and the Sequence of Aux Video Frames, the Target Aux Audio Frame Matching the Target Lead Audio Frame

At step 640, the processor 110 may be configured to synchronize the sequence of lead video frames 302 and the sequence of aux video frames 304. The processor 110 may perform synchronization using a target lead audio frame and a target aux audio frame. In some embodiments, the processor 110 may be configured to assign index values to respective audio frames based on pre-determined audio features from the reference audio signal. Index value comparison may be employed for performing matching of lead audio frames with aux audio frames. It can be said that the aux sequence of audio frames and/or the aux sequence of video frames may be synchronized to the lead sequence of audio frames and/or the lead sequence of video frames using matched aux audio frame(s) and lead audio frame(s).

### Step 650: Generating at Least One Artificial Video Frame for at Least One of the Sequence of Lead Video Frames and the Sequence of Aux Video Frames

At step 650, the processor 110 is configured to generate at least one artificial video frame for at least one of the sequence of lead video frames and the sequence of aux video frames. The processor 110 may be configured to generate at least one of the artificial video frame 450, the artificial first aux video frames 460, and the artificial first aux video frames 470. The at least one artificial video frame may be generated using the interpolator 400.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A method for video frame alignment, the method executable by a processor, the method comprising:
triggering playback of a reference audio signal;
acquiring lead camera data from a lead camera device, the lead camera data being indicative of a sequence of lead video frames and a corresponding sequence of lead audio frames,
the sequence of lead video frames and the corresponding sequence of lead audio frames have been recorded during playback of the reference audio signal;
acquiring aux camera data from at least one aux camera device, the aux camera data including a sequence of aux video frames and a corresponding sequence of aux audio frames,
the sequence of aux video frames and the corresponding sequence of aux audio frames have been recorded during playback of the reference audio signal;
synchronizing, using a target lead audio frame and a target aux audio frame, the sequence of lead video frames and the sequence of aux video frames, the target aux audio frame matching the target lead audio frame; and
generating at least one artificial video frame for at least one of the sequence of lead video frames and the sequence of aux video frames,
thereby generating aligned sequences of lead video frames and aux video frames.

2. The method of claim 1, wherein the lead camera device has a first frame rate, and the at least one aux camera device has a second frame rate, the first frame rate being different from the second frame rate.

3. The method of claim 1, wherein the method further comprises identifying the target lead audio frame and the target aux audio frame using audio features of reference audio signal.

4. The method of claim 1, wherein the lead camera device is a standalone camera device.

5. The method of claim 1, wherein the at least one aux camera device is a standalone camera device.

6. The method of claim 1, wherein at least one of the sequence of lead audio frames and the sequence of aux audio frames has been recorded at a sampling rate of 48000 Hz.

7. The method of claim 1, wherein at least one of the sequence of lead video frames and the sequence of aux video frames has been recorded at a sampling rate of 100 Hz.

8. The method of claim 1, wherein the generating the at least one artificial video frame comprises generating, using a Neural Network, an artificial lead video frame by interpolating at least two temporally adjacent lead video frames.

9. The method of claim 1, wherein the generating at least one artificial video frame comprises generating, using a Neural Network, an artificial aux video frame by interpolating at least two temporally adjacent aux video frames.

10. The method of claim 1, wherein the method further comprises executing 3D scene reconstruction using the aligned sequences of lead video frames and aux video frames.

11. A system comprising:
a lead camera device;
at least one aux camera device; and
a processor configured to:
trigger playback of a reference audio signal;
acquire lead camera data from the lead camera device, the lead camera data being indicative of a sequence of lead video frames and a corresponding sequence of lead audio frames,
the sequence of lead video frames and the corresponding sequence of lead audio frames have been recorded during playback of the reference audio signal;
acquire aux camera data from at least one aux camera device, the aux camera data including a sequence of aux video frames and a corresponding sequence of aux audio frames,
the sequence of aux video frames and the corresponding sequence of aux audio frames have been recorded during playback of the reference audio signal;
synchronize, using a target lead audio frame and a target aux audio frame, the sequence of lead video frames and the sequence of aux video frames, the target aux audio frame matching the target lead audio frame; and
generate at least one artificial video frame for at least one of the sequence of lead video frames and the sequence of aux video frames,
thereby generating aligned sequences of lead video frames and aux video frames.

12. The system of claim 11, wherein the lead camera device has a first frame rate, and the at least one aux camera device has a second frame rate, the first frame rate being different from the second frame rate.

13. The system of claim 11, wherein the processor is further configured to identify the target lead audio frame and the target aux audio frame using audio features of reference audio signal.

14. The system of claim 11, wherein the lead camera device is a standalone camera device.

15. The system of claim 11, wherein the at least one aux camera device is a standalone camera device.

16. The system of claim 11, wherein at least one of the sequence of lead audio frames and the sequence of aux audio frames has been recorded at a sampling rate of 48000 Hz.

17. The system of claim 11, wherein at least one of the sequence of lead video frames and the sequence of aux video frames has been recorded at a sampling rate of 100 Hz.

18. The system of claim 11, wherein to generate the at least one artificial video frame comprises the processor configured to generate, using a Neural Network, an artificial lead video frame by interpolating at least two temporally adjacent lead video frames.

19. The system of claim 11, wherein to generate the at least one artificial video frame comprises the processor configured to generate, using a Neural Network, an artificial aux video frame by interpolating at least two temporally adjacent aux video frames.

20. The system of claim 11, wherein the processor is further configured to execute 3D scene reconstruction using the aligned sequences of lead video frames and aux video frames.
